(19) United States
(12) Patent Application Publication
(10) Pub. No.: US 2008/0264231 A1
(43) Pub. Date: Oct. 30, 2008

(54) SAW BLADE

(76) Inventors: Andrew Coe, Wharehine (NZ); Craig Davidson, Cornelius, NC (US); Matthew Gillanders, Wellsford (NZ); Ken Hall, East Longmeadow, MA (US); Martin Murphy, Northland (NZ); Barry Walton, Mathesons Bay (NZ)

Correspondence Address: MOORE & VAN ALLEN PLLC, P.O. BOX 13706, Research Triangle Park, NC, 27709, US

(21) Appl. No.: 11/739,932

(22) Filed: Apr. 25, 2007

(51) Int. Cl. B23D 57/00

(52) U.S. Cl. 83/835

(57) ABSTRACT

A saw blade comprises a plate having a plurality of teeth. Each of the teeth includes a tip where the tip has a smooth curved surface welded to the plate. The tip comprises a solid piece of hard material and has a generally rounded wedge shape. A method of forming a saw blade having cutting tips welded to the plate is also provided.

### BACKGROUND OF THE INVENTION

Saw blades comprising a steel plate having a plurality of teeth formed on the plate are known. The teeth may comprise a tooth formed integrally with the plate with a tip is brazed onto each tooth. The conventional saw blade having a tip brazed onto each tooth, while relatively straight forward to manufacture, is less durable and has a shorter maximum life, especially in abusive situations such as nail strikes, than is desirable. Attempts to weld traditionally shaped tips onto the steel plate have resulted in cracking in the tip/plate interface due to stresses caused by the welding process. Further, in order to be cost effective, any process for attaching the tips to the plate must not require extensive subsequent processes to obtain the final tip geometry.

Thus, an improved saw blade tooth construction, saw blade and blade manufacturing process that allow the tip to be welded to the plate in a manner that provides a strong tip/plate interface and that is economical to manufacture is desired.

### SUMMARY OF THE INVENTION

A saw blade comprises a plate having a plurality of teeth. Each of the teeth includes a tip where the tip has a smooth curved surface welded to the plate. The tip comprises a solid piece of hard material and has a generally rounded wedge shape. A method of forming a saw blade comprises providing a plate having pockets formed therein. A tip having a generally rounded wedge shape is welded to the plate.

### BRIEF DESCRIPTION OF THE DRAWINGS

FIG. 1 is a side view of an embodiment of a saw blade with the tip/plate interface of the invention.

FIG. 2 is a perspective view showing an embodiment of a tip.

FIG. 3 is a side view showing another embodiment of a tip.

FIG. 4 illustrates an embodiment of the welding process of the invention.

FIG. 5 illustrates another embodiment of the welding process of the invention.

FIG. 6 illustrates yet another embodiment of the welding process of the invention.

FIG. 7 is a side view of an embodiment of the final tip shape.

FIG. 8 is a perspective view showing another embodiment of the tip.

FIG. 9 is a flow chart illustrating the welding process of the invention.

### DETAILED DESCRIPTION OF EMBODIMENTS OF THE INVENTION

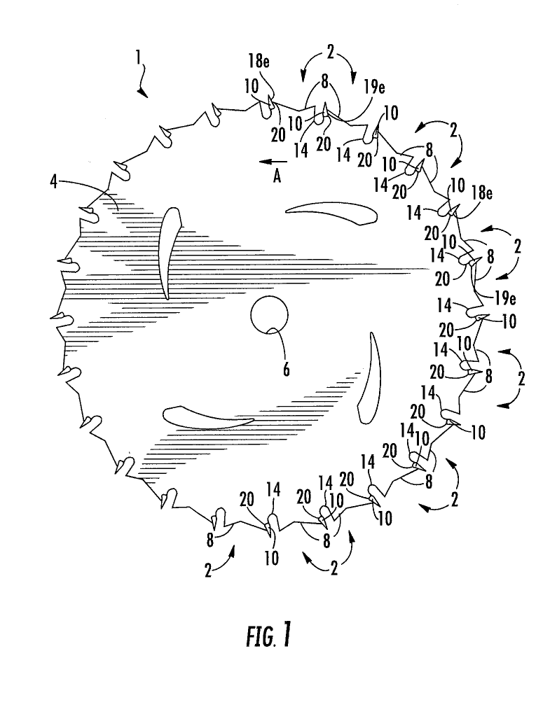

FIG. 1 shows a side view of one embodiment of the saw blade 1 of the invention. Blade 1 is a circular saw blade and has twenty-four teeth 2 arranged about the periphery of plate 4. It is to be understood that the invention can be used with a saw blade having any number of teeth and that the twenty-four tooth blade is used by way of example only. A hole 6 is centrally located in plate 4 to attach the saw blade to the arbor of a rotary tool such as a circular saw, table saw, powered miter saw or the like in a known manner. The blade 1 is rotated in the direction of arrow A by the rotary tool as is known in the art.

Each tooth 2 consists of a tooth support 8 supporting cutting tip 10. Tooth support 8 may be formed integrally with the plate 4, and extends radially from the periphery of the plate 4. A gullet 14 may be formed between each of the teeth defining the areas between the teeth. In one embodiment cutting tip 10 is formed of a hard material such as tungsten carbide welded onto the tooth supports 8 at tip pockets 20. Tips 10 typically would be made of a material having a high hardness and would ordinarily be of a harder and more expensive material than plate 4 and tooth supports 8. In one embodiment the plate 4 is made of steel and the tips 10 are made of carbide.

The use of a resistance welded joint between the tip 10 and the plate 4 provides higher bond strength between the tips 10 and plate 4 when compared to a brazed joint and will result in longer blade life and better durability especially in abusive situations such as nail strikes. It has been determined, based on tests using traditional shaped and sized carbide tips welded onto the plate, that the welding of such tips results in cracking of the carbide caused by stresses imparted during the welding process and a lack of fusion at the joint due to a lack of electrical contact and a suitable concentrated electrical pathway between the tip and the plate.

To avoid these problems a tip having a particular geometry has been developed that reduces the internal stressing of the carbide tip and provides a desired current path during the welding process. The tip shape also minimizes the amount of excess material that must be removed subsequent to the welding process to obtain the final tip geometry.

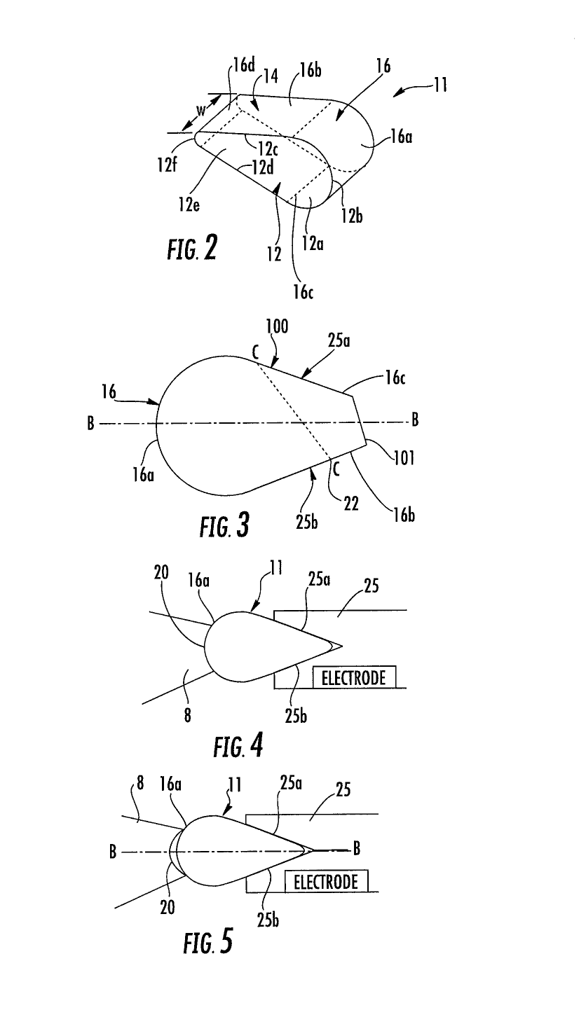

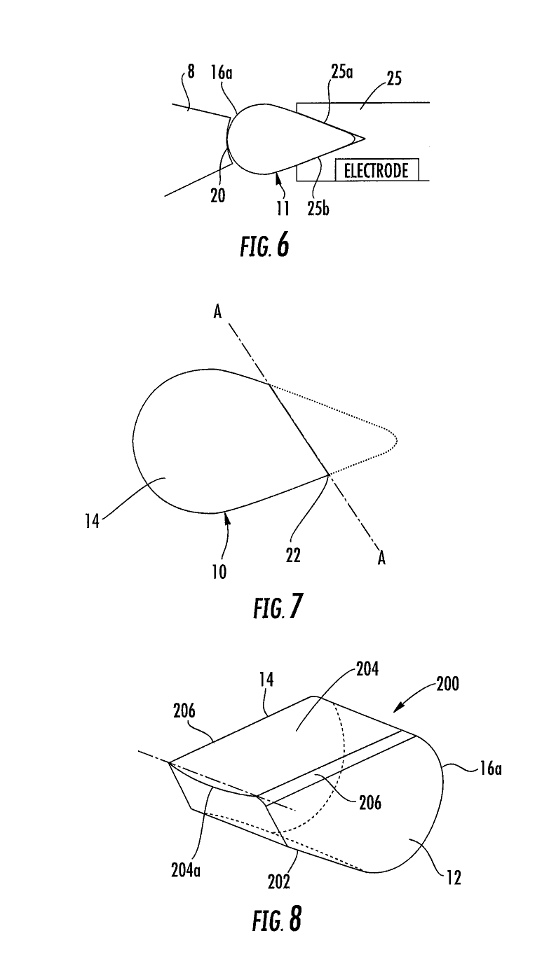

Referring to FIG. 2, the tip 10 is a solid piece of hard material and has a generally tear drop or rounded wedge shape having a first side face 12 disposed substantially parallel to a second side face 14. In one embodiment side faces 12 and 14 have the same general shape and size such that specific reference will be made to side face 12. Side face 12 has an enlarged bottom portion 12a the edge 12b of which is formed as an arc of a circle or similar smooth curved surface. Edge 12b transitions into side edges 12c and 12d that are substantially straight and that extend toward each other such that the top portion 12e of tip 12 tapers to a rounded point 12f. Peripheral face 16 joins side faces 12 and 14 and is dimensioned such that the width W of the tip corresponds to or nearly corresponds to the final width of the tip. Typically the width of tip 10 is slightly greater than the width of tooth supports 8 and plate 4. Peripheral face 16 has a relatively large rounded portion 16a that corresponds to edge 12b and two flat side portions, leading face 16b and trailing face 16c, that correspond to side edges 12c and 12d. Leading face 16b and trailing face 16c angle toward one another from large rounded portion 16a to the relatively smaller rounded tip 16d. Tip 10 is symmetrical about its longitudinal axis B-B, shown in FIG. 5, from between the points of contact 25a and 25b with electrode 25 and rounded portion 16a. The tip is not symmetrical about a line perpendicular to axis B-B.

Each tooth support 8 comprises a pocket 20 for receiving the rounded portion 16a of tip 10. The pocket 20 may be arranged such that there is full contact between the pocket and rounded portion 16a as best shown in FIG. 4. With full contact the entire surface of the pocket 20 contacts the tip 10. The pocket 20 may be arranged such that there is double contact between the pocket 20 and the rounded portion 16a of tip 10 as best shown in FIG. 5. With double contact the end portions of the pocket 20 contact the tip 10. The pocket 20 may also be arranged such that there is single contact between the pocket and the rounded portion 16a as best shown in FIG. 6. With single contact a central portion of the pocket 20, less than the full pocket, contacts the tip 10.

To join a tip 10 to the pocket 20 a welding operation is used. A tip 10 shaped as disclosed herein is provided (block 901). A plate 4 having a tip pocket 20 is also provided (block 902). Tip 10 is positioned in the pocket 20 as described above such that the tip contacts the pocket (block 903). An electrode 25 contacts the opposite flat sides 16b and 16c of the tip (block 904) and typically a force is applied to the tip such that the tip 10 is held against the pocket 20 under pressure (block 905). The opposed flat side portions 16b and 16c ensure that good contact is achieved between the electrode 25 and the tip 10 both to create the pressure contact between the blade and the tip and to ensure good current flow between the electrode and the tip. Current is applied to the tip 10 via electrode 25 (block 906). Because the tip 10 is essentially symmetric from between the contact points 25a and 25b of the electrode 25 and rounded portion 16a, current flows evenly around rounded portion 16a and the contact point(s) with the pocket 20 such that an even resistance weld is made between the tip and the plate.

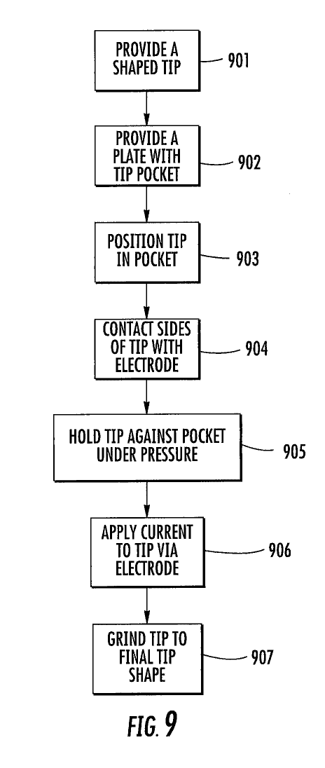

After the tip is welded to the plate, the tip is ground to create the final tip shape (block 907). Referring to FIG. 7, the tip 10 is ground to line A-A such that a sharp cutting edge 22 is created along the leading face of tip 10. The final cutting edge 22 and final tip shape can be achieved with a single grinding operation by removing only the small tapered area of the tip. The sides 12 and 14 of the tip 10 may also be ground to create a final width of the tip if desired.

In one embodiment the tip 10 may be coated such as with a Nickel coating. The coating helps with the electrical contact between the tip and the electrode and also acts as a bonding aid in that it increases the metallurgical bond because it reacts with both the carbide tip 10 and steel plate 4 to create increased bond strength when compared to a non-coated tip. A coating such as a Nickel coating may also be used with the tips shown in FIGS. 3 and 8.

An alternate embodiment of the tip is shown in FIG. 3 where the tip 100 includes peripheral face 16 having a large rounded portion 16a and two flat portions, leading face 16b and trailing face 16c. Unlike the tip shown in FIG. 2, the flat potions 16b and 16c do not extend to a rounded point. Instead faces 16b and 16c are truncated and terminate in an end face 101 that is closer to the size, shape and location of the finished ground face defining edge 22 as represented by dashed line C-C. Using the truncated tip minimizes the grinding operation because less material must be removed to create cutting edge 22 and thereby minimizes the post welding process. The tip 100, although truncated, maintains the opposed side faces 16b and 16c that are symmetrical about the axis of the tip from between the points of contact 25a and 25b with electrode 25 and rounded portion 16a. As a result, current flows evenly around the curved face 16a as previously described.

Another embodiment of the tip is shown in FIG. 8 where tip 200 includes opposed side faces 12 and 14, and rounded portion 16a. The tip further includes a flat trailing face 202 and an opposed leading face 204. The leading face 204 has a scooped profile where the face has a concave surface, the center portion 204a being recessed along its length as compared to the longitudinal edges 206. The longitudinal edges 206 may also be chamfered. Tip 200 is smaller and lighter than the tips of FIGS. 2 and 3 and has particular applicability where a reduction in power draw is important such as in cordless saws. The tip of FIG. 8 uses the truncated configuration previously described with respect to FIG. 3.

Specific embodiments of an invention are described herein. One of ordinary skill in the art will recognize that the invention has other applications in other environments. In fact, many embodiments and implementations are possible. The following claims are in no way intended to limit the scope of the invention to the specific embodiments described above.

1. A saw blade comprising:
a plate having a plurality of teeth;
each of said teeth including a tip, said tip having a rounded wedge shape and
having a smooth curved surface welded to said plate; and
a cutting edge formed in the tip.

2. A tip for attachment to a saw blade comprising:
a solid piece of hard material formed to have a rounded wedge shape.

3. The tip of claim 2 having a first side face disposed substantially parallel to a second side face, said first and second side faces having an enlarged bottom portion which is formed as a smooth curved surface.

4. The tip of claim 3 further including a tapered portion extending from the enlarged bottom portion.

5. The tip of claim 3 wherein two flat faces extend from the enlarged bottom portion, said two flat face portions extend toward one another as they extend from said enlarged bottom portion.

6. The tip of claim 2 wherein said tip is symmetrical about its longitudinal axis for at least a portion of its length.

7. The tip of claim 2 wherein the tip is tungsten carbide.

8. A method of forming a saw blade comprising:
providing a plate having pockets formed therein;
providing a tip having a generally rounded wedge shape; and
welding the tip to the plate.

9. The method of claim 8 wherein said tip has first and second faces and an enlarged bottom portion.

10. The method of claim 9 wherein said tip further includes a tapered portion extending from the enlarged bottom portion.

11. The method of claim 8 wherein said tip is symmetrical about its longitudinal axis for at least a portion of its length.

12. The method of claim 11 contacting the tip with an electrode in said portion.

13. The method of claim 8 locating a tip in each of said pockets such that said enlarged portion contacts said pocket.

14. The method of claim 8 grinding the tip to a finished shape.

15. The method of claim 8 grinding a sharp cutting edge on the tip.

16. A saw blade comprising:
a plate;
a plurality of teeth formed on said plate, said teeth including a tooth support defining a pocket;
a tip welded in said pocket.

17. The saw blade of claim 16 wherein said tip has an enlarged bottom portion which is formed as a smooth curved surface and a tapered portion extending from the enlarged bottom portion.

18. The saw blade of claim 17 wherein the tapered portion includes a leading face and a trailing face that extend toward one another as they extend away from the enlarged bottom portion.

19. The saw blade of claim 17 wherein the tapered portion extends to a rounded point.

20. The saw blade of claim 17 wherein the tapered portion extends to a truncated face.
